(19) United States
(12) Patent Application Publication
(10) Pub. No.: US 2012/0324160 A1
(43) Pub. Date: Dec. 20, 2012

(54) METHOD FOR DATA ACCESS, MESSAGE RECEIVING PARSER AND SYSTEM

(76) Inventors: Yijun LIU, Shenzhen (CN); Qingming LU, Shenzhen (CN)

(21) Appl. No.: 13/597,979

(22) Filed: Aug. 29, 2012

Related U.S. Application Data
(63) Continuation of application No. PCT/CN2011/074561, filed on May 24, 2011.

(30) Foreign Application Priority Data
Nov. 26, 2010 (CN) 201010575885.X

(51) Int. Cl. G06F 12/00

(52) U.S. Cl. 711/112; 711/E12.001

(57) ABSTRACT

The present invention discloses a method for access data, a message receiving parser and system, which belong to the field of network technology. The method comprises: receiving a data access request; determining a hard disk to be accessed by the data access request according to the data access request; sending the data access request to a message queue associated with the hard disk such that the hard disk may complete data access according to the data access request. The message receiving parser comprises: a receiving module, a determining module and a sending module. The system comprises: a message receiving parser, at least one hard disk and message queues associated with each hard disk.

### CROSS-REFERENCE TO RELATED APPLICATIONS

This application is a continuation of International Application No. PCT/CN2011/074561, filed on May 24, 2011, which claims priority to Chinese Patent Application No. 201010575885.X, flied on Nov. 26, 2010, both of which are hereby incorporated by reference in their entireties.

### TECHNICAL FIELD

The present invention relates to the field of a storage technology, and more specifically, to a method for data access, a message receiving parser and a system.

### DESCRIPTION OF THE RELATED ART

RAID (Redundant Array of Independent Disks) is a redundant array consisting of multiple hard disks. RAID technology combines multiple hard disks together such that these multiple hard disks serve as one independent large-scaled storage device in an operating system.

There are several RAID levels, and among all of these levels, RAID 0 has the rapidest storage speed. It's principle is to divide the continuous data into multiple data blocks and then disperse these, multiple data blocks onto the multiple hard disks for access. Thus, when the system has a data request, it will be executed by the multiple hard disks in parallel, with each hard disk executing a portion of the data request that belongs to itself. Such parallel operation on data can make full use of the bandwidth of a bus. Compared with a serial transmission of mass data, the overall access speed of the hard disks is enhanced significantly.

During the implementation of the present invention, the inventor has found at least the following defects in the prior art:

RAID 0 employs a technology of using a single channel to read multiple hard disks, putting all data requests in one queue to queue up and then sequentially executing the data requests in the queue. The waiting time delay of a data request in the queue is a sum of the time cost for executing all previous data requests, which results in a phenomenon that the further back a data request locates in the queue, the longer the waiting time delay thereof is, thereby forming an effect of waiting time delay accumulation. Thus, for all the data requests, their respective waiting time delays are different and the storage system gives unequal responses. Consequently, when a large number of data requests access concurrently, the data request locating hack in the queue has a longer waiting time delay and a slower access speed.

### SUMMARY OF THE INVENTION

In order to make the waiting time delay of each data access request uniform when a large number of data access requests access a storage system concurrently, the embodiments of the present invention provide a method and a device for data access. This technical solution is as follows:

On one aspect, a method for data access is provided, which comprises:

receiving a data access request;

determining a hard disk to be accessed by the data access request according to the data access request;

sending the data access request to a message queue associated with the hard disk such that the hard disk completes data access according to the data access request.

On another aspect, a message receiving parser for data access is provided, the message receiving parser comprises:

a receiving module configured to receive a data access request;

a determining module configured to determine a hard disk to be accessed by the data access request according to the data access request received by the receiving module;

a sending, module configured to send the data access request to a message queue associated with the hard disk determined by the determining module such that the hard disk completes data access according to the data access request.

On a further aspect, a system for data access is provided, the system comprises: a message receiving parser, at least one hard disk, and message queues associated with each hard disk;

the message receiving parser is configured to receive a data access request; determine a hard disk to be accessed by the data access request according to the data access request; and send the data access request to a message queue associated with the hard disk;

the message queues associated with each hard disk are configured to store a data access request corresponding to the hard disk;

the each hard disk is configured to complete data access according to data access requests in the message queues associated with the hard disk.

The technical solution provided in the embodiments of the present invention has the following beneficial effects.

The present invention implements quick access of data in multi-disk and multi-channel by generating, for each hard disk, a message queue associated with the hard disk, distributing the received data access requests to the corresponding message queues to queue up and processing in parallel, such that the waiting time delay of each data access request is uniform when a large number of data access requests access a storage system concurrently. This enhances the data access speed of a cheap server that is configured with multiple hard disks

### BRIEF DESCRIPTION OF THE DRAWINGS

In order to more clearly explain the technical solution in the embodiments of the present invention, the drawings that are used in the description of the embodiments will be briefly introduced. Obviously, however, the drawings in the following description are only some embodiments of the present invention. One of ordinary skill in the art can obtain other drawings based on these drawings without paying any creative efforts.

FIG. 1 is a flowchart of a method for data access provided by Embodiment One of the present invention;

FIG. 2 is a flowchart of a method for data access provided by Embodiment Two of the present invention;

FIG. 3 is a flowchart of a method for flow control management provided by Embodiment Two of the present invention;

FIG. 4 is a flowchart of a method for processing between a message queue associated with a hard disk and a data read-and-write task bound thereto provided by Embodiment Two of the present invention;

FIG. 5 is a structural diagram of a first message receiving parser for data access provided by Embodiment Three of the present invention;

FIG. 6 is a structural diagram of a second message receiving parser for data access provided by Embodiment Three of the present invention;

FIG. 7 is a structural diagram of a third message receiving parser for data access provided by Embodiment Three of the present invention;

FIG. 8 is a structural diagram of a first system for data access provided by Embodiment Four of the present invention;

FIG. 9 is a structural diagram of a second system for data access provided by Embodiment Four of the present invention.

### DETAILED DESCRIPTION OF THE PREFERRED EMBODIMENT

Below, the embodiments of the present invention will be described in greater detail in conjunction with the drawings, such that the objects, the technical solutions and the advantages of the present invention will become clearer.

### Embodiment One

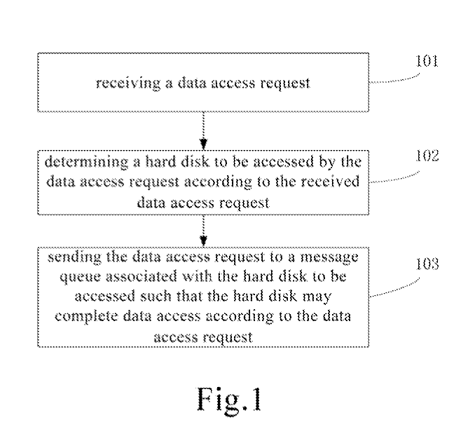

This embodiment of the present invention provides a method for data access. With reference to FIG. 1, the flow of the method particularly goes as follows:
101: receiving a data access request;
102: determining a hard disk to be accessed by the data access request according to the received data access request;
103: sending the data access request to a message queue associated with the hard disk to be accessed such that the hard disk may complete data access according to the data access request.

The method provided by this embodiment of the present invention implements quick access of data in multi-disk and multi-channel by generating, for each hard disk, a message queue associated with the hard disk, distributing the received data access requests to the corresponding message queues to queue up and processing in parallel, such that the waiting time delay of each data access request is uniform when a large number of data access requests access a storage system concurrently. This can increase the data access speed of a cheap server configured with multiple hard disks up to 1.5 to 2 times of that in the industry. The method provided by this embodiment of the present invention can be directly applied to a cheap server configured with multiple hard disks by means of software and reduces the cost of a storage system platform. Comparatively speaking, in terms of hardware. RAID technology employs a RAID card for providing a processor and a memory and the cost of a storage system platform is expensive. The method provided by this embodiment has an advantage in enhancing access speed and reducing costs.

### Embodiment Two

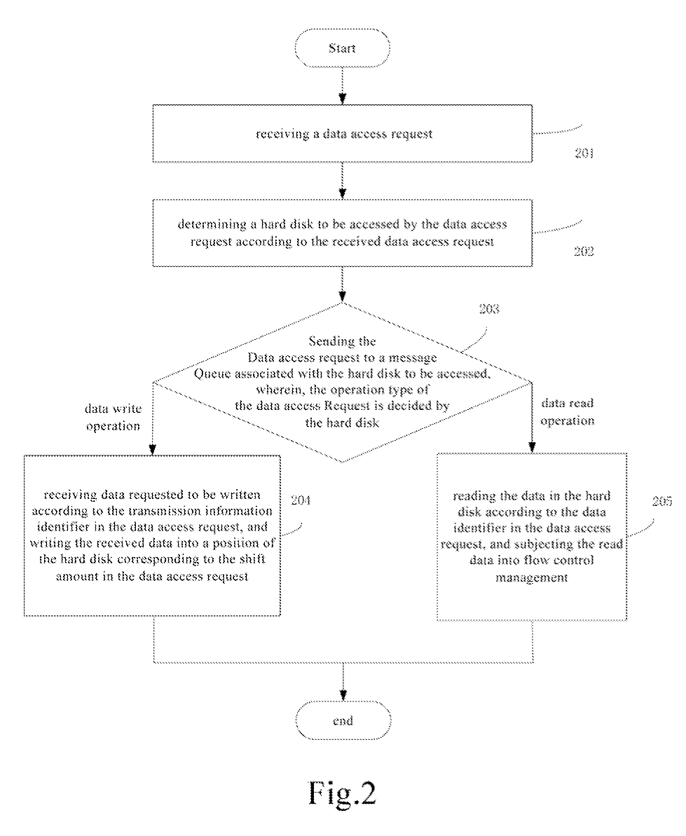

This embodiment of the present invention provides a method for data access. With reference to FIG. 2, the flow of the method particularly goes as follows:
201: receiving a data access request;

Specifically, a storage system receives a data access request sent from an entity. The storage system includes at least one hard disk, with each hard disk being associated with a message queue and being bound to one data read-and-write task. The message queue is configured to chronologically store data access requests belonging to a hard disk associated with the message queue, and the data read-and-write task reads data access requests from the corresponding message queues. This embodiment of the present invention does not make any specific limitations on the entity for sending data access requests, and this entity can be a client.

Wherein, the data access request contains data identifier, operation type (data read or data write), transmission information identifier (e.g. socket identifier), shift amount, data length, or the like. This embodiment of the present invention does not make any specific limitations on the contents contained in the data access request.
202; determining a hard disk to be accessed by the data access request according to the received data access request;

Specifically, the received data access request is parsed, thereby obtaining contents contained in this data access request, such as, data identifier, operation type, transmission information identifier, shift amount, data length, or the like.

Further, a hard disk to be accessed by the data access request is determined according to an operation type in the parsed data access request, which specifically comprises:

deciding an operation type of the data access request:

if the operation type is a data write operation, a hard disk associated with a message queue with the fewest waiting data access requests and having a remaining storage space larger than the length of data requested to be written is determined as a hard disk to be accessed by the data access request, or a hard disk associated with a message queue with the fewest waiting data write requests and having a remaining storage space larger than the length of data requested to be written is determined as a hard disk to be accessed by the data access request;

if the operation type is a data read operation, a hard disk having data to be read stored thereon is determined as a hard disk to be accessed by the data access request.
203: sending the data access request to a message queue associated with the hard disk to be accessed, wherein, the operation type of the data access request is decided by the hard disk, if it is a data write operation, then step 204 is performed, and if it is a data read operation, then step 205 is performed;

Specifically, the data access request is sent to a message queue associated with the hard disk to be accessed such that the hard disk completes data access according to the data access request.

Wherein, the operation type of the data access request is decided by the hard disk, specifically speaking, the hard disk reads the data access request from the message queue and decides the operation type of the data access request, that is, the data read-and-write task hound to the hard disk reads the data access request from the message queue and decides whether the operation type of the data access request is a data write operation or a data read operation, and then the hard disk completes the data access according to the data access request, see steps 204 and 205 for detail.

Further, this embodiment of the present invention does not make any specific limitations on the manner of reading data access requests from message queues. All the waiting data access requests can be read from the message queue at one time, or the data access requests may be read from the message queue sequentially.
204: if the operation type, is a data write operation, receiving the data requested to be written according to the transmission information identifier in the data access request, and writing the received data into a position of the hard disk corresponding to the shift amount in the data access request, and then the flow ends;

Specifically, the data read-and-write task hound to the hard disk receives data uploaded by an entity according to a port specified by the transmission information identifier (e.g. socket identifier) in the parsed data access request, and writes the received data into a corresponding position of the hard disk according to the shift amount in the data access request, and then completes the data write, and the flow ends.
205: if the operation type is a data read operation, reading the data in the hard disk according to the data identifier in the data access request, and subjecting the read data into flow control management, and then the now ends.

Specifically, the data read-and-write task bound to the hard disk reads the data in the hard disk that is the same as the data identifier in the data access request, and sends the read data to a flow control manager for flow control management, the flow control manager sends the data to a corresponding entity, and then the data read completes.

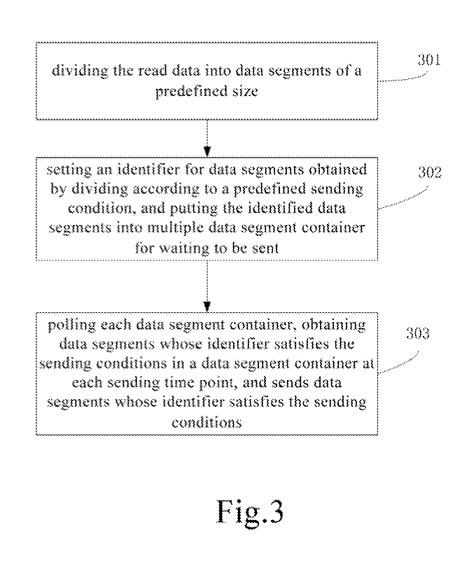

The above steps 201 to 205 particularly can be performed by the message receiving parser.

Wherein, with reference to FIG. 3, the flow regarding that the flow control manager subjects the above read data into flow control management and sends the data to a corresponding entity goes as follows:
301: the flow control manager divides the received read data into data segments of a predefined size;

Wherein, this embodiment of the present invention does not make any specific limitations on the data segments divided into a predefined size. The data can be divided into data segments of a system predefined size or can be divided into data segments having a predefined size as required in the data access request, in the farmer case, the predefined size is predefined by the system at the time when the storage system starts. In the latter case, the predefined size is a predefined size of a data segment as required in each data access request sent by entities, so as to satisfy different data transmission bit rates required by the respective entities.
302: the flow control manager sets an identifier for data segments obtained by dividing according to a predefined sending condition, and puts the identified data segments into multiple data segment containers for waiting to be sent;

This step particularly goes as follows: rating the data segments in turn according to the number of data segment containers and setting an identifier for each level of data segments in turn, wherein, data segments at the same level have the same identifier; putting data segments of the same level into the respective data segment containers in an order starting from the first data segment container according to a polling sequence, for waiting to be sent.

In particular, data segments obtained, by dividing each block of data are rated according to the number of data segment containers, starting from the first level. The number of data segments at each level is the same as the number of data segment containers. An identifier is set for each level of data segments in turn starting from the first level. Data segments at the same level have the same identifier, and the identifiers for data segments at different levels are incremental (or descending, or in other manner, the embodiment of the present invention does not make any limitations on this point). Data segments at the same level are put into the respective data segment containers starting from the first data segment container according to a polling sequence (e.g. the dividing order or shift amount), for waiting to be sent.

For example, there are n data segment containers (n is a natural number larger than or equal to 1). The first data segment to the nth data segment obtained by dividing are rated as the first level, and all the n data segments at the first level are identified as 0. Starting from the first data segment container, the first data segment is put into the first data segment container, the second data segment is put into the second data segment container, and so on, until the nth data segment is put into the nth data segment container. The (n+1)th data segment to the (2n)th data segment obtained, by dividing are rated as the second level, and all the n data segments at the second level are identified as 1. Starting from the first data segment container, the (n+1)th data segment is put into the first data segment container, the (n+2)th data segment is put into the second data segment container, and so on, until the to (2n)th data segment is put into the nth data segment container. The operation continues until all data segments obtained by dividing the same block of data are identified and put into the data segment containers, that is, the identifier for the first level of data segments put into the data segment container is 0, the identifier for the second level of data segments put into the data segment container is 1, and so on, the identifier for the mth (m is a natural number larger than or equal to level of data segments put into the data segment container m−1, until all data segments obtained by dividing the same block of data are identified and put into the data segment container. At the time of identifying and putting data segments obtained by dividing the next block of data into the data segment containers, these data segments are rated, identified and put into the data segment containers in a manner as mentioned above.
303: the flow control manager polls each data segment container, obtains data segments whose identifier satisfies the sending conditions in one data segment container at each sending time point, and sends data segments whose identifier satisfies the sending conditions.
This step particularly goes as follow: polling each data segment container, obtaining a data segment having a first level identifier in a data segment container at each sending time point, and sending the data segment; moving the identifiers of data segments waiting to be sent in all data segment containers forward h one level after each polling and sending, and continuing polling.

Wherein, this embodiment of the present invention does not make any specific limitations on the manner of polling, that is, the data segment containers can be polled in turn continuously, or can be polled periodically. Each time when the last data segment container is polled, the polling is executed once again starting from the first data segment container.

In particular, starting from the first data segment container, data segment containers are polled in turn, and a data segment having the first level identifier in a data segment container that is currently being polled is sent to a corresponding entity at each sending time point.

For example, as in step 302, starting from the first data segment container, a data segment having an identifier of 0 in a data segment container is sent at each sending time point; after the n data segment containers completes one round of sending, data segments in the data segment containers have their own identifiers reduced by one (moving forward by one level), such that a data segment having an identifier of 0 can be sent to a corresponding entity during the next round of polling.

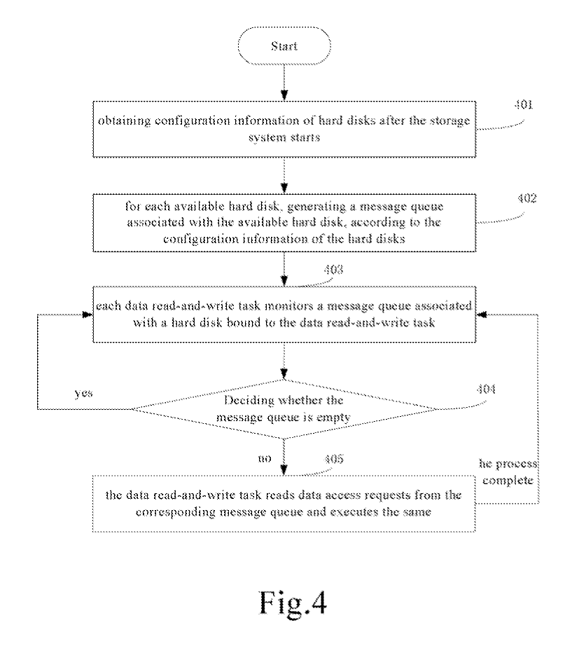

Further, with reference to FIG. 4, the flow of the processing between a message queue associated with a hard disk and a data read-and-write task hound to the hard disk provided in this embodiment of the present invention particularly goes as follows:
401: obtaining configuration information of hard disks after the storage system starts;

Wherein, this embodiment of the present invention does not make any specific limitations on the manner of obtaining configuration information of hard disks, that is, configuration information of hard disks can be obtained by reading a configuration file containing the configuration information of the hard disks, or can be obtained in an automatic detection manner. The configuration information of the hard disk includes information such as identifiers of available hard disks. This embodiment of the present invention does not make any specific limitations on other contents contained in the configuration information of the hard disks.
402: generating, for each available hard disk, a message queue associated with the available hard disk, according to the configuration information of the hard disks:

Specifically, each available hard disk is associated with a message queue belonging to the hard disk, and is bound to a data read-and-write task belonging to the hard disk, wherein, the data read-and-write task is configured to process data access requests in the message queue of the bound hard disk. Associating a hard disk with a message queue can be understood as that there is a one-to-one correspondence between the hard disk and the message queue, that is, each hard disk has an associated message queue that is set specifically for this hard disk, and each message queue can be configured to only store data access requests belonging to the associated hard disk.
403: each data read-and-write task monitors a message queue associated with a hard disk bound to the data read-and-write task;

Wherein, the message queue is configured to store data access requests belonging to an associated hard disk chronologically.
404: deciding whether or not the message queue is empty; if it is, step 403 is performed; and if it is not, step 405 is performed;

Wherein, the message queue is configured to store data access requests belonging to an associated hard disk chronologically.
405: the data read-and-write task reads data access requests from the corresponding message queue and executes the same, and after the read data access requests are processed, return to step 403, to continue monitoring the corresponding message queue.

Wherein, this embodiment of the present invention does not: make any specific limitations on the manner in which the data read-and-write task reads data access requests from the corresponding message queue and executes the same. All the waiting data access requests can be read from the message queue at one time, that is, all the data access requests in the current message queue are exported into the data read-and-write task at one time, the data read-and-write task executes the imported data access requests in turn, and after all the data access requests are processed, the message queue is monitored again and all the data access requests in the message queue are exported. Alternatively, data access requests can be read sequentially from the message queue, that is, only data access request located foremost in the message queue is exported at one time while the remaining data access requests respectively move forward by one level, the data read-and-write task performs this imported data access request, and after this data access request is processed, the message queue is monitored again and the data access request located foremost in the message queue is exported.

The method provided by this embodiment of the present invention implements quick access of data in multi-disk and multi-channel by generating, for each hard disk, a message queue associated with the hard disk and a data read-and-write task bound to the hard disk, distributing the received data access requests to the corresponding message queues to queue up and process in parallel, such that the waiting time delay of each data access request is uniform when a large number of data access requests access a storage system concurrently. This can increase the data access speed of a cheap server configured with multiple hard disks up to 1.5 to 2 times of that in the industry. The method provided by this embodiment of the present invention employs a flow control manager to send data to a corresponding entity such that entities sending the data access requests can read data uniformly and provides required bit rate for entities by setting the size of data segments. The method provided by this embodiment of the present invention can be directly applied to a cheap server configured with multiple hard disks by means of software and reduces the cost of a storage system platform.

### Embodiment Three

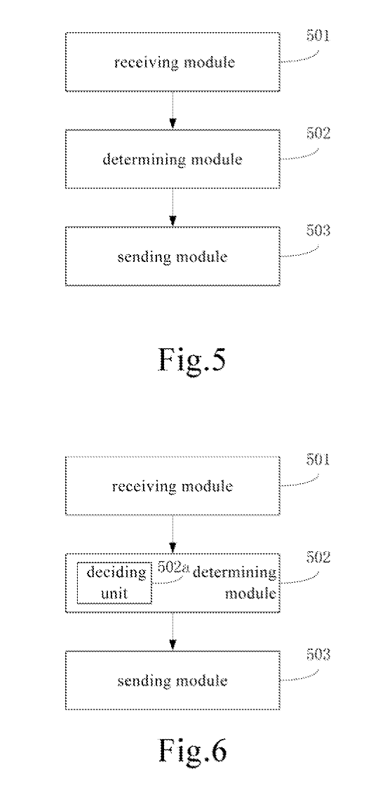

With reference to FIG. 5, this embodiment of the present invention provides a message receiving parser for data access, wherein, this message receiving parser includes:
a receiving module 501 configured to receive a data access request;
a determining module 502 configured to determine a hard disk to be accessed by the data access request according to the data access request received by the receiving module 501;

a sending module 503 configured to send the data access request to a message queue associated with the hard disk determined by the determining module 502, such that the hard disk may complete data access according to the data access request.

Wherein, with reference to FIG. 6, the determining module 502 particularly comprises:

a deciding unit 502a configured to decide an operation type of the data access request received by the receiving module 501 if the operation type is a data write operation, a hard disk associated with a message queue with the fewest waiting data access requests and having a remaining storage space larger than the length of data requested to be written is determined as a hard disk to be accessed by the data access request, or a hard disk associated with a message queue with the fewest waiting data write requests and having a remaining storage space larger than the length of data requested to be wrote is determined as a hard disk to be accessed by the data access request if the operation type is a data read operation, a hard disk having data to be read stored thereon is determined as a hard disk to be accessed by the data access request.

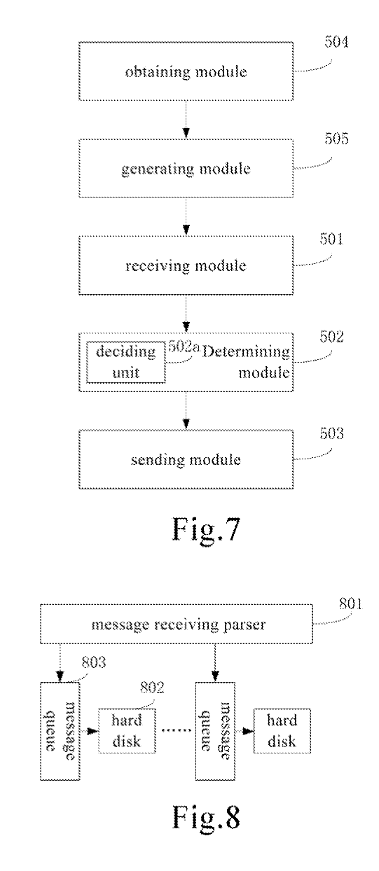

Further, with reference to FIG. 7, the message receiving parser also comprises:

an obtaining module 504 configured to obtain configuration information of hard disks;

a generating module 505 configured to generate, for each available hard disk, a message queue associated with the available hard disk, according to the configuration information obtained by the obtaining module 504.

Wherein, the obtaining module 504 particularly is configured to store configuration information of hard disks by reading a configuration file containing configuration information of hard disks, or to obtain configuration information of hard disks in an automatic detection manner.

The message receiving parser provided by this embodiment of the present invention implements quick access of data in multi-disk and multi-channel by generating, for each hard disk, a message queue associated with the hard disk, distributing the received data access requests to the corresponding message queues to queue up and process in parallel, such that the waiting time delay of each data access request is uniform when a large number of data access requests access a storage system concurrently. This can increase the data access speed of a cheap server configured with multiple hard disks up to 1.5 to 2 times of that in the industry.

### Embodiment Four

With reference to FIG. 8, this embodiment of the present invention provides a system for data access which comprises: a message receiving parser 801, hard disk(s) 802 (at least one), and message queues 803 associated with each hard disk;

wherein the message receiving parser 801 is configured to receive a data access request: determine a hard disk to be accessed by the data access request according to the data access request; and send the data access request to a message queue associated with the hard disk;

the message queues 803 associated with each hard disk are configured to store the data access requests corresponding to the hard disk.

each hard disk 802 is configured to complete data access according to data access requests in the message queues 803 associated with each hard disk 802.

Wherein, the message receiving parser 801 can comprise:

a determining module configured to decide an operation type of the data access request: if the operation type is a data write operation, a hard disk associated with a message queue with the fewest waiting data access requests and having a remaining storage space larger than the length of data requested to be written is determined as a hard disk to be accessed by the data access request, or a hard disk associated with a message queue with the fewest waiting data write requests and having a remaining storage space larger than the length of data requested to be written is determined as a hard disk to be accessed by the data access request if the operation type is a data read operation, a hard disk having data to be read stored thereon is determined, as a hard disk to be accessed, by the data access request.

In particular, the hard disk 802 can comprise:

an accessing module configured to read the data access request from the message queue 803 and decide an operation type of the data access request: if the operation type is a data write operation, the accessing module receives data requested to be written according to the transmission information identifier in the data access request, and writes the received data into a position of the hard disk 802 corresponding to the shift amount in the data access request; if the operation type is a data read operation, the accessing module reads the data in the hard disk 802 according to the data identifier in the data access request, and sends the read data to the flow control manager 804 for flow control management.

Wherein, the accessing module of the hard disk 802 can read all the waiting data access requests from the message queue 803 at one time, or can read the data access requests from the message queue 803 sequentially.

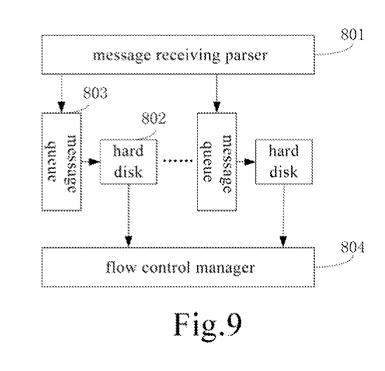

Further, with reference to FIG. 9, this system also comprises:

a flow control manager 804 configured to subject the read data sent by the hard disk 802 into a dividing process so as to divide the data into data segments of a predefined size; set an identifier for each data segment according to a predefined sending condition and put the identified data segments into multiple data segment containers for waiting to be sent; poll each data segment container, obtain data segments whose identifier satisfies the sending condition in a data segment container at each sending time point, and send data segments whose identifier satisfies the sending condition.

Wherein, the flow control manager 804 can comprise:

a dividing module configured to subject the read data sent by the hard disk 802 into a dividing process so as to divide the data into data segments of a system predefined size or divide into data segments of a predefined size as required in the data access request.

Particularly, the flow control manager 804 can comprise:

a flow controlling module configured to rate the data segments according to the number of data segment containers and set an identifier for each level, of data segments, wherein, data segments at the same level have the same identifier; put data segments of the same level into the respective data segment containers in order starting from the first data segment container according to a polling sequence, for waiting to be sent; poll each data segment container, obtain a data segment having a first level identifier in a data segment container at each sending time point, and send the data segment; move the identifiers of data segments waiting to be sent in all data segment containers forward by one level after each polling and sending, and continue polling.

Furthermore, the message receiving parser 801 also can comprise:

a generating module is configured to obtain configuration information of hard disks before the message receiving parser 801 receives the data access request, and generate, for each available hard disk, a message queue associated with the available hard disk, according to the configuration information.

Wherein, the generating module of the message receiving parser 801 can obtain configuration information of hard disks by reading a configuration file containing configuration information of hard disks, or can obtain configuration information of hard to disks in an automatic detection manner.

In summary, this embodiment of the present invention implements quick access of data in multi-disk and multi-channel by generating, for each hard disk, a message queue associated with the hard disk and a data read-and-write task bound to the hard disk, distributing the received data access requests to the corresponding message queues to queue up and process in parallel, such that the waiting time delay of each data access request is uniform when a large number of data access requests access a storage system concurrently. This can increase the data access speed of a cheap server configured with multiple hard disks up to 1.5 to 2 times of that in the industry. This embodiment of the present invention employs a flow control manager to send data to a corresponding entity such that entities for sending data access requests can read data uniformly and provides required bit rate for entities by setting the size of data segments. The method provided by this embodiment of the present invention can be directly applied to a cheap server configured with multiple hard disks by means of software and reduces the cost of a storage system platform.

It needs to be noted that, the message receiving parser for data access provided by the above embodiments are exemplarily described using the above functional modules, when it is configured to process data access requests. In practical application, the above functionalities can be assigned to and completed by different functional modules as needed. That is, the inner structure of the message receiving parser can be divided into different functional modules, so as to complete all or a part of the above-described functions. In addition, the message receiving parser for data access and the method for data access provided by the above embodiments belong to similar design. Thus, as for the detailed implementation process of the message receiving parser for data access, reference also can be made to the method embodiment, and, thus details thereof are omitted.

The serial numbers of the above embodiments of the present invention are merely descriptive, but do not represent the order of excellence of these embodiments.

All or some steps in the embodiments of the present invention can be realized by means of software. The corresponding software programs can be stored in a readable storage medium, such as, optical disk or hard disk, and can be executed by a computer.

All or some steps in the embodiments of the present invention can be integrated into a hardware device and can be realized as an independent hardware device.

The above are merely some preferred embodiments of the present invention, but are not limitations of the present invention. All modifications, equivalent replacements, and improvements made within the sprit and principle of the present invention shall be contained within the claimed scope of the present invention.

What is claimed is:

1. A method for data access, comprising:
receiving a data access request;
determining a hard disk to be accessed by the data access request according to the data access request;
sending the data access request to a message queue associated with the hard disk such that the hard disk completes data access according to the data access request.

2. The method of claim 1, wherein the determining a hard disk to be accessed by the data access request according to the data access request comprises:
deciding an operation type of the data access request:
if the operation type is a data write operation, a hard disk associated with a message queue with the fewest waiting data access requests and having a remaining storage space larger than the length of data requested to be written is determined as the hard disk to be accessed by the data access request, or a hard disk associated with a message queue with the fewest waiting data write requests and having a remaining storage space larger than the length of data requested to be written is determined as the hard disk to be accessed by the data access request;
if the operation type is a data read operation, a hard disk having data to be read stored thereon is determined as the hard disk to be accessed by the data access request.

3. The method of claim 1, wherein the hard disk completing data, access according to the data access request comprises:
reading the data access request from the message queue and deciding an operation type of the data access request:
if the operation type is a data write operation, receiving data requested to be written according to a transmission information identifier in the data access request, and writing the received data into a position of the hard disk corresponding to a shift amount in the data access request;
if the operation type is a data read operation, reading data in the hard disk according to a data identifier in the data access request, and subjecting the read data to flow control management.

4. The method of claim 3, wherein the subjecting the read data to flow control management comprises:
dividing the read data into data segments of a predefined size;
setting identifiers for the data segments according to a predefined sending condition and putting the identified data segments into multiple data segment containers for waiting to be sent;
polling each data segment container, obtaining a data segment whose identifier satisfies the sending condition in a data segment container at each sending time point, and sending the data segment whose identifier satisfies the sending condition.

5. The method of claim 4, wherein the setting an identifier for the data segments according to a predefined sending condition and putting the identified data segments into multiple data segment containers for waiting to be sent, polling each data segment container, obtaining a data segment whose identifier satisfies the sending condition in a data segment container at each sending time point, and sending the data segment whose identifier satisfies the sending condition, comprises:
rating the data segments according to the number of data segment containers and setting an identifier for each level of the data segments, wherein, data segments of the same level have the same identifier;
putting data segments of the same level into the respective data segment containers in order starting from the first data segment container according to a polling sequence, for waiting to be sent;
polling each data segment container, obtaining a data segment having a first level identifier in a data segment container at each sending time point, and sending the data segment;
moving the identifiers of data segments waiting to be sent in all data segment containers forward by one level after each polling and sending, and continuing polling.

6. The method of claim 1, characterized in that, before receiving the data access request, the method further comprises:
obtaining configuration information of hard disks;
generating, for each available hard disk, a message queue associated with the available hard disk, according to the configuration information.

7. A message receiving parser for data access, comprising:
a receiving module configured to receive a data access request;
a determining module configured to determine a hard disk to be accessed by the data access request according to the data access request received by the receiving module;
a sending module configured to send the data access request to a message queue associated with the hard disk determined by the determining module such that the hard disk completes data access according to the data access request.

8. The message receiving parser of claim 7, wherein the determining module comprises:
a deciding unit configured to decide an operation type of the data access request received by the receiving module: if the operation type is a data write operation, a hard disk associated with a message queue with the fewest waiting data access requests and having a remaining storage space larger than the length of data requested to be written is determined as the hard disk to be accessed by the data access request, or a hard disk associated with a message queue with the fewest waiting data write requests and having a remaining storage space larger than the length of data requested to be written is determined as the hard disk to be accessed by the data access request; if the operation type is a data read operation, a hard disk having data to be read stored thereon is determined as the hard disk to be accessed by the data access request.

9. The message receiving parser of claim 7, wherein the message receiving parser further comprises
an obtaining module configured to obtain configuration information of hard disks;
a generating module configured to generate, for each available hard disk, a message queue associated with the available hard disk, according to the configuration information obtained by the obtaining module.

10. A system for data access, comprising: a message receiving parser, at least one hard disk, and message queues associated with each hard disk:
wherein the message receiving parser is configured to receive a data access request; determine a hard disk to be accessed by the data access request according to the data access request; and send the data access request to a message queue associated with the hard disk;
the message queues associated with each hard disk are configured to store a data access request corresponding to the hard disk;
the each hard disk is configured to complete data access according to data access requests in the message queues associated with the hard disk.

11. The system of claim 10, wherein the message receiving parser comprises:
a determining module configured to decide an operation type of the data access request: if the operation type is a data write operation, a hard disk associated with a message queue with the fewest waiting data access requests and having a remaining storage space larger than the length of data requested to be written is determined as a hard disk to be accessed by the data access request, or a hard disk associated with a message queue with the fewest waiting data write requests and having a remaining storage space larger then the length of data requested to be written is determined as a hard disk to be accessed by the data access request; if the operation type is a data read operation, a hard disk having data to be read stored thereon is determined as a hard disk to be accessed by the data access request.

12. The system of claim 10, wherein the hard disk comprises:
an accessing module configured to read the data access request from the message queue and decide an operation type of the data access request: if the operation type is a data write operation, the accessing module receives data requested to be written according to a transmission information identifier in the data access request, and writes the received data into a position of the hard disk corresponding to a shift amount in the data access request; if the operation type is a data read operation, the accessing module reads the data in the hard disk according to a data identifier in the data access request, and sends the read data to a flow control manager for flow control management.

13. The system of claim 12, wherein the system further comprises:
a flow control manager configured to divide the read data sent by the hard disk into data segments of a predefined size; set an identifier for each data segment according to a predefined sending condition and put the identified data segments into multiple data segment containers for waiting to be sent; poll each data segment container, obtain data segments whose identifier satisfies the sending condition in a data segment container at each sending time point, and send data segments whose identifier satisfies the sending condition.

14. The system of claim 13, wherein the flow control manager comprises:
a flow controlling module, at the time of setting an identifier for the data segments according to a predefined sending condition and putting the identified data segments into multiple data segment containers for waiting to be sent, polling each data segment container, obtaining a data segment whose identifier satisfies the sending condition in a data segment container at each sending time point, and sending the data segment whose identifier satisfies the sending condition, the flow control module sequentially rates the data segments according to the number of data segment containers and sets an identifier for each level of data segments, wherein, data segments at the same level have the same identifier; puts data segments of the same level into the respective data segment containers in order starting from the first data segment container according to a polling sequence, for waiting to be sent; polls each data segment container, obtaining a data segment having a first level identifier in a data segment container at each sending time point, and sends the data segment; Move the identifiers of data segments waiting to be sent in all data segment containers forward by one level after each polling and sending, and continuing polls.

15. The system of claim 10, wherein the message receiving parser also comprises:
a generating module configured to obtain configuration information of hard disks before the message receiving parser receives the data access request, and generate, for each available hard disk, a message queue associated with the available hard disk, according to the configuration information.
